(19) United States
(12) Patent Application Publication
(10) Pub. No.: US 2013/0142213 A1
(43) Pub. Date: Jun. 6, 2013

(54) METHOD FOR MEASURING CORROSION IN A CONCRETE BUILDING

(71) Applicants: Fabien Barberon, Puteaux (FR); Philippe Gegout, Les Breviaires (FR); Julien Lopez-Rios, Saint Ismier (FR)

(72) Inventors: Fabien Barberon, Puteaux (FR); Philippe Gegout, Les Breviaires (FR); Julien Lopez-Rios, Saint Ismier (FR)

(21) Appl. No.: 13/520,978

(22) PCT Filed: Jan. 7, 2011
(86) PCT No.: PCT/EP11/50162

§ 371 Date: Jul. 6, 2012

(30) Foreign Application Priority Data
Jan. 8, 2010 (FR) 1050100

(51) Int. Cl. G01N 25/72

(52) U.S. Cl. CPC G01N 25/72
USPC 374/5

(57) ABSTRACT

The invention relates to a process for controlling the corrosion of a concrete structure, in which said structure includes at least one sensor comprising a metal element located at a determined depth between the surface of the concrete and the first reinforcement bed, said process including the measurement of the corrosion of said metal element by implementing:
the induction heating of said metal element, by applying magnetic excitation above the surface of the structure,
the production of at least one thermographic image of the surface of the structure,
and the deduction, on the basis of the thermographic image, of the degree of corrosion of the metal element.

The invention also relates to a process for producing a concrete structure, in which at least one sensor including a metal element is placed in the concrete in order to subsequently implement said corrosion inspection process.

### FIELD OF THE INVENTION

This invention relates to a process for measuring corrosion of a metal element in a concrete structure.

### BACKGROUND OF THE INVENTION

The control of the corrosion of metal elements, such as reinforcements, in reinforced concrete structures, is an important issue in the field of civil engineering, since it is aimed at ensuring the safety of said structures.

Non-destructive control methods have been developed to this end.

Thus, document WO 2009/007395 describes sensors enabling the corrosion of metal reinforcements in concrete structures to be controlled.

These sensors, which are embedded in the concrete volume, consist of a corrosion-resistant substrate and a metal element, for example a thin layer, of which the surface state is arranged to initiate and guide the propagation of the corrosion, in order to prevent random corrosion of the various sensors.

The corrosion of sensors at various depths is indicative of the rate of progression of the corrosion front.

These sensors use the property of electromagnetic waves to penetrate the metals only over a very shallow depth (less than the thickness of the blade used as a sensor) and instead to easily penetrate the oxidized metals and more generally the materials having a dielectric character, such as concrete.

The tool chosen to detect this property was the radar (GHz).

Indeed, the radar wave is reflected by the non-oxidized metal sensors and passes through the oxidized sensors. There is therefore a radar signature only for the non-oxidized sensors.

However, radar detection has certain disadvantages.

In particular, it is difficult to obtain measurements at a shallow depth (i.e. in the first 2 or 3 centimetres below the surface of the concrete).

In addition, the interpretation of measurements is especially difficult.

Finally, the device is costly and the measurement instrument has a high weight and volume, making on-site measurements difficult.

There are alternatives for detecting this electromagnetic property of metals: for example, the modifications of magnetic fields associated with Foucault currents are used to detect mines or metals.

Nevertheless, these methods have the major disadvantage, with respect to radar, of providing an image of the objects only after a complex analysis.

It would be desirable to be capable of observing the sensors and monitoring their corrosion continuously.

The objective of this invention is therefore to find a process for observing the oxidation of sensors that enables images with better resolution to be obtained, and that is less expensive and easier to implement.

Another objective of the invention is to enable the corrosion, even at a very low depth below the surface of the concrete, to be measured.

### BRIEF DESCRIPTION OF THE INVENTION

According to the invention, a process is proposed for controlling the corrosion of a concrete structure, in which said structure includes at least one sensor comprising a metal element located at a determined depth between the surface of the concrete and the first reinforcement bed, said process being characterized in that it includes, for said sensor, the measurement of the corrosion of said metal element by implementing:
the induction heating of said metal element, by applying magnetic excitation above the surface of the structure,
the production of at least one thermographic image of the surface of the structure, and the deduction, on the basis of the thermographic image, of the degree of corrosion of the metal element.

According to a possible embodiment of the process, a plurality of successive thermographic images are obtained after the magnetic excitation is stopped, so as to measure the change over time in the temperature of said metal element.

According to another possible embodiment of the process, if the structure comprises a plurality of metal elements capable of having different corrosion levels, a plurality of successive thermographic images are obtained after the magnetic excitation has been stopped, so as to distinguish, by their temperature, at least two metal elements visible in said images.

Preferably, the magnetic excitation is applied with a magnetic field having an intensity greater than 0.1 mT, a frequency of between 10 kHz and 1 MHz and at a distance of between 0.1 cm and 10 cm with respect to the surface of the structure.

Particularly advantageously, the sensor is arranged at a depth of between 0.1 and 10 cm below the surface of the concrete.

According to a preferred embodiment, the sensor consists of a metal sheet of which the thickness is between 20 and 500 micrometers, and which is substantially parallel to the surface of the concrete.

Optionally, the metal element includes a surface state suitable for controlling the localization of the initiation of the corrosion and, as the case may be, the propagation of same.

Preferably, the dimensions of the metal element and the duration of the magnetic excitement are chosen so as to lead to an increase in its temperature by at least 2° C.

Another objective of the invention finally relates to a process for producing a concrete structure, in which at least one sensor including a metal element is placed in the concrete in order to subsequently implement the corrosion inspection process described above.

### BRIEF DESCRIPTION OF THE DRAWINGS

Other features and advantages of the invention will become clear from the following detailed description, in reference to the appended drawings, in which:

FIG. 1 is a diagram showing the principle of the invention,

FIG. 2 shows the arrangement of sensors in a concrete block used in the first experimental example,

FIGS. 2A to 2D show the thermographic images of the surface of the concrete block of FIG. 2 obtained at different times after the magnetic excitation has been stopped,

FIG. 3 shows the arrangement of sensors in a concrete block used in the second experimental example,

FIGS. 3A and 3B show the thermographic images (a) of the surface and (b) of the side of the concrete block of FIG. 3 obtained at different times after the magnetic excitation has been stopped,

FIGS. 4A and 4B are graphs showing, respectively, the dependence of the temperature reached by a sensor as a function of the thickness of the concrete under which it is located, as well as the temperature reached by sensors of different sizes and for different excitation times as a function of the thickness of the concrete covering said sensors,

FIG. 5 shows the arrangement of a sensor and a metal bar in a concrete block used in the third experimental example,

FIG. 5A shows the thermographic images (a) of the surface and (b) of the side of the concrete block of FIG. 5 obtained at different times after the magnetic excitation has been stopped.

### DETAILED DESCRIPTION OF THE INVENTION

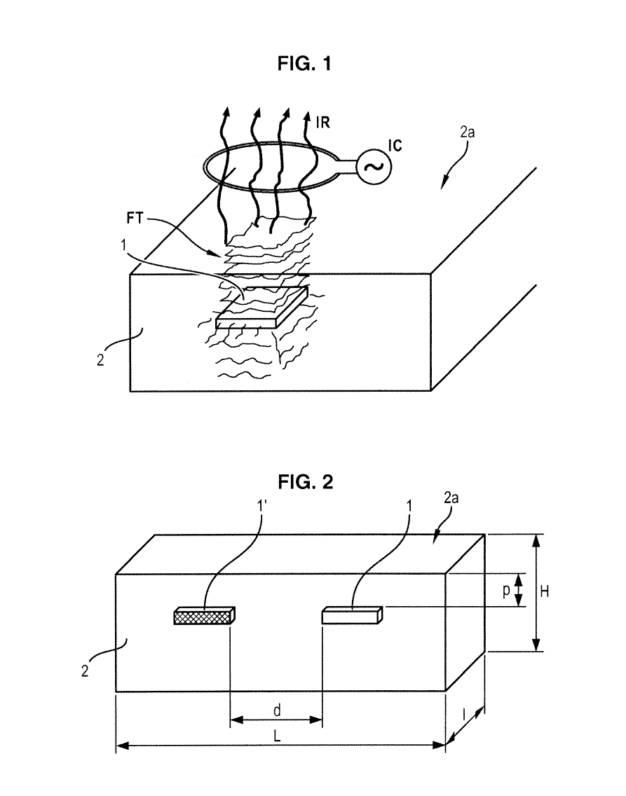

FIG. 1 shows the principle of the invention.

At least one sensor 1 is embedded in a concrete volume 2.

A coil is positioned near the surface 2a of the concrete volume 2, and opposite the sensor 1, in which coil an alternating current IC circulates and is capable of generating an induced current in the sensor 1.

An intact sensor, i.e. with little or no oxidation, is heated by induction, while an oxidized sensor is not.

The heated sensor 1 generates a heat flow FT through the concrete volume, which increases the temperature at the surface 2a, producing an increase in the infrared IR photon emission in an area of which the shape and surface correspond substantially to those of the sensor.

A thermal image obtained by means of an infrared camera enables the heated sensors to be viewed, and their level of oxidation to be deduced therefrom.

Recent developments in infrared thermography make it possible to measure, with non-cooled and affordable cameras, variations of less than 0.1° C.

### Sensor

In general, the sensor can be any object including, at the surface, at least one metal element, regardless of its shape (plane, cube, sphere, wire, etc.).

However, the sensitivity of the measurement will vary from one shape to another.

Preferably, a sensor with a planar shape will be chosen, which will be arranged parallel to the surface of the concrete.

Thus, according to an embodiment, the sensor may be, as in document WO 2009/007395, in the form of a planar substrate made of a corrosion-resistant material (for example plastic or ceramic), on which a metal element is applied, consisting of a metal layer having a surface state suitable for controlling the localization of the initiation of the corrosion, and, as the case may be, the progression of same.

Said metal layer generally has a thickness of between 20 and 500 μm, with the thickness of the substrate being on the order of 100 μm to 1 cm.

However, the sensor preferably consists solely of a metal element (for example, an iron sheet), insofar as the components of other materials would be capable of absorbing the heat flow emitted by the metal element and therefore disrupting the measurement.

The thickness of said metal element is preferably between 20 and 500 μm, with a person skilled in the art being capable of determining the optimal thickness as a function of the expected sensitivity of the sensor. Thus, the thicker the metal element is, the more it will have to be corroded in order for the corrosion to be detectable by thermographic imaging: this type of sensor will therefore be advantageous when it is desirable to inspect the corrosion of the structure after a long lifetime. However, if it is desirable to be capable of controlling the presence of corrosion a short time after construction of the structure, a finer metal element will be chosen.

In addition, the surface of the metal element may have at least one discontinuity, for example one or more scratches of which the depth is between 1 and 50 μm and having acute angle with the surface of the metal layer.

This particular surface state enables the corrosion to be initiated at these scratches, then spread along them.

The production of such sensors and the various embodiments are described in detail in document WO 2009/007395 and will not therefore be described again in detail here.

However, a person skilled in the art may choose not to provide such a discontinuity at the surface of the sensor.

### Heating System

The induction heating system typically includes a high-frequency current generator, a coil powered by said generator and the element to be heated, which is electrically conductive (in this case, the sensor 1).

The principle of operation is based on Lenz's law, which enables the transfer by induction of the electromagnetic energy from one circuit to another. Indeed, a turn or a coil through which an electric current passes generates a magnetic field. If this magnetic field varies periodically in the vicinity of a conductor, Foucault currents are generated in said conductor that, by virtue of Ohm's law, produce heat. This enables the metal sensor to be heated without contact.

At high frequency, the currents circulate only at the periphery of the conductors (skin effect). Therefore, for the coil, a plurality of mutually insulated wires are preferably used to maximize the volume in which the currents circulate and thus optimize the heating.

As an example, a prototype was produced with a coil 10 to 15 cm in diameter, consisting of wires 2 mm in diameter, but a person skilled in the art is capable of defining other coil dimensions as a function of the magnetic field to be generated.

Advantageously, the coil generates an alternating magnetic field with a frequency of 27 kHz, which is fairly powerful for heating the sensor 1 embedded under several centimetres of concrete.

The effective value of the alternating magnetic field thus generated at 4 cm in the air is then around 50 mT.

It is possible, however, to choose a frequency of between 10 kHz and 1 MHz, by taking into account the fact that the more the frequency is increased, the greater the sensitivity to corrosion will be.

The technology for generating the magnetic field may optionally be modified as a function of the intensity to be obtained (for example, superconductivity for intense magnetic fields).

### Infrared Thermography

For thermal imaging measurements, it is possible to use, for example, an infrared thermographic camera T200 sold by FLIR, which has a resolution of 200×150 pixels, and a thermal sensitivity of less than 0.1° C.

The spatial variations in intensity of the infrared light are measured on the images.

It is thus possible to perform a calibration by associating, with a given degree of corrosion, a given temperature after a given time after the end of the excitation.

### Experimental Example No. 1

### Effect of the Corrosion

As an experiment, a thin concrete block 15 cm in length L, 6 cm in height H and 4 cm in width l is used.

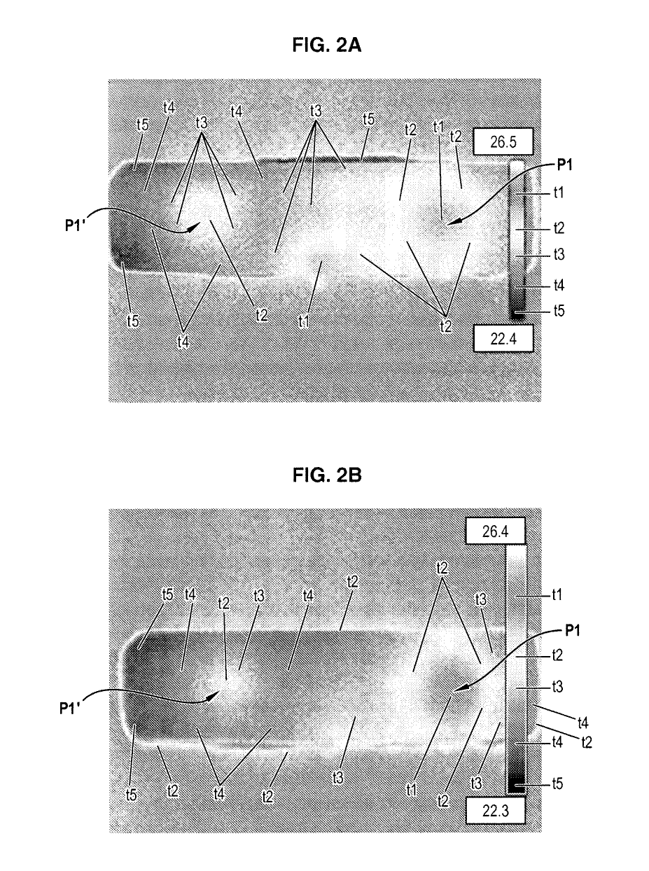

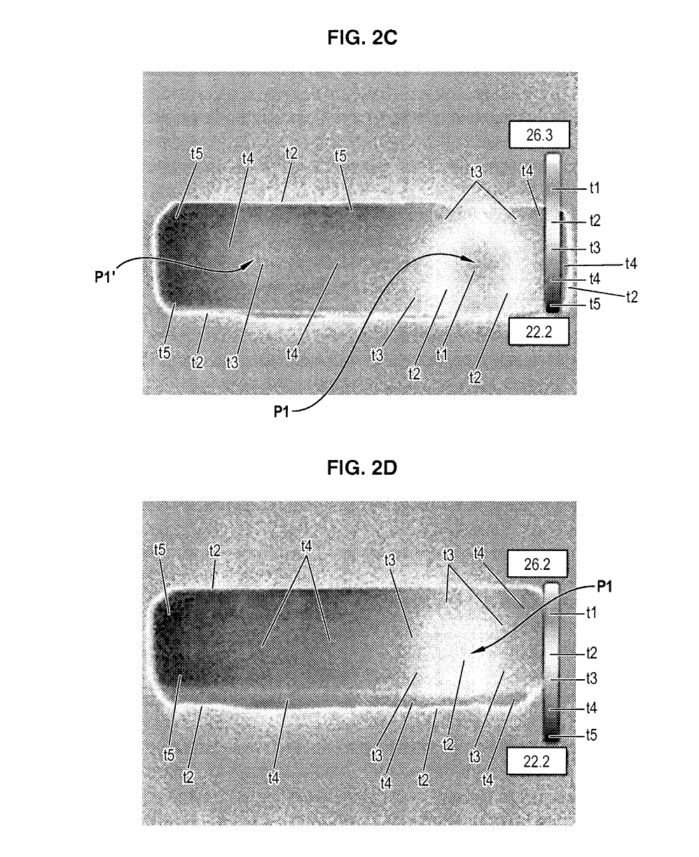

In reference to FIG. 2, two sensors 1, 1′ were first embedded in this block: sensor 1 is intact, i.e. non-oxidized, while sensor 1′ is partially corroded.

In all of the examples below, the sensors consist of a 99.99% pure iron sheet placed during the pouring of the concrete.

The dimensions of the sensors 1, 1′ are: a width and a length of 2 cm×2 cm, and a thickness of 100 micrometers.

The two sensors are located at a depth p of 2 cm below the surface 2a of the block and are separated by a distance d of around 7 cm.

The block is then excited by electromagnetic induction for 50 seconds by means of the system described above (frequency of 27 kHz), and thermal images of the surface 2a of the block are taken a different moments after the excitation is stopped, for 5 minutes.

FIG. 2A shows the thermographic image obtained just after the excitation is stopped.

In this figure, as in FIGS. 2B to 2D, 3A, 3B and 4A, a scale is provided to the right of the photograph indicating the minimum and maximum temperatures measured, expressed in ° C. In addition, the iso-temperature areas of the surface of the block are identified by a number preceded by the letter t and referenced on the temperature scale.

A hot point P1, P1′ is observed at the right of each of the embedded sensors 1, 1′. (A third hot point can be seen in the lower central portion: it is due to the handling of the block 2 by an operator and, as will be seen in the next figures, it diminishes very quickly.)

In addition, the non-corroded sensor 1 generates a hot point P1 at a higher temperature than that of the hot point P1′ generated by the partially coloured sensor 1′ (that is, respectively, around 26.5° C. by comparison with 24.5° C.).

FIG. 2B shows the thermographic image obtained 30 seconds after the end of the excitation.

It is observed that the hot point P1 generated by the non-corroded sensor 1 continues to be very intense, while the hot point P1′ generated by the partially corroded sensor 1′ diminishes. It is also noted that the hot point generated by the operator's fingers has practically disappeared.

FIG. 2C shows the thermographic image obtained 70 seconds after the end of the excitation.

It may be noted that hot point P1′ has practically disappeared, while hot point P1 preserves its initial intensity.

Finally, FIG. 2D shows the thermographic image obtained 110 seconds after the end of the excitation.

The hot point associated with the partially corroded sensor 1′ has totally disappeared, while the hot point P1 generated by the non-corroded sensor 1 remains visible, but with a lower temperature (around 24° C.).

After 5 minutes, the hot point P1 is no longer distinguished, as the surface temperature of the block 2 has returned to a uniform temperature.

### Experimental Example No. 2

### Effect of the Depth

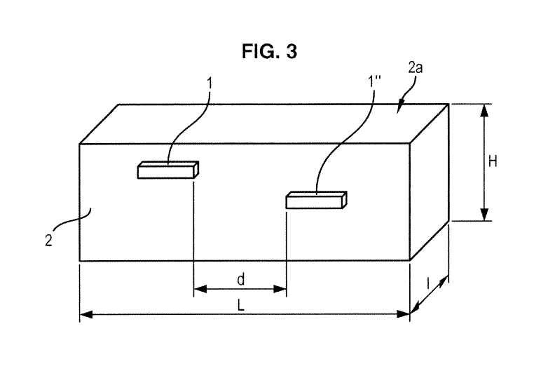

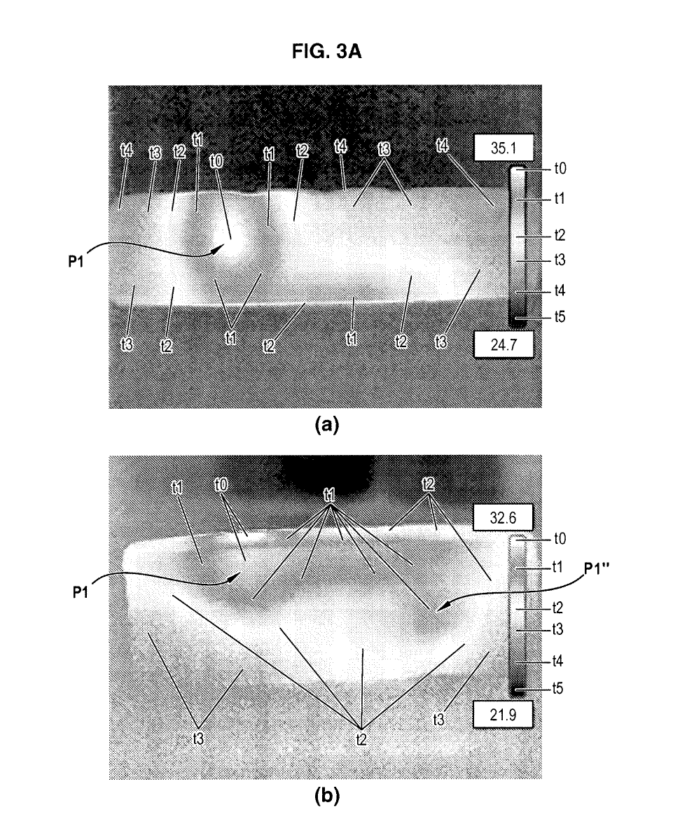

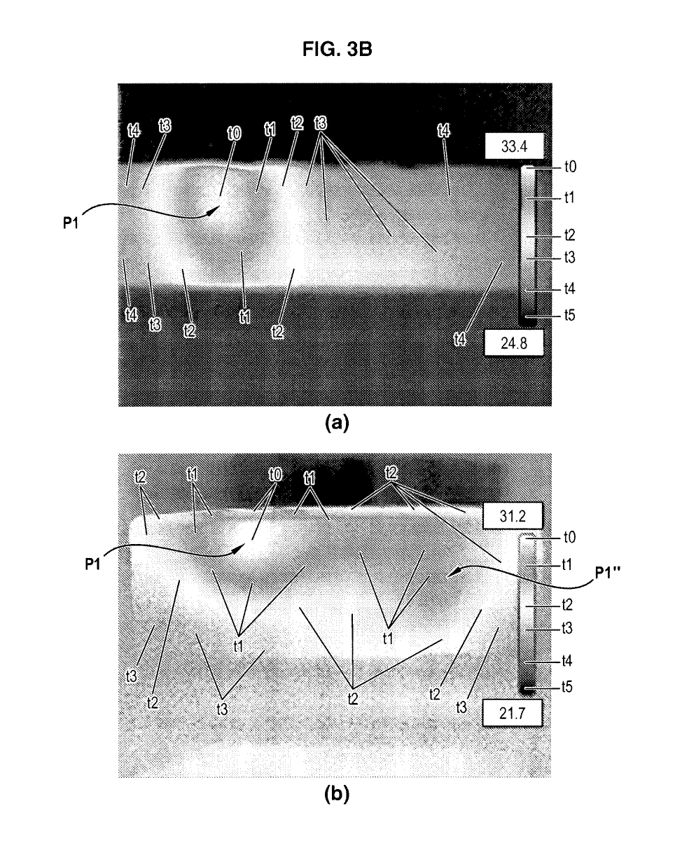

In this second example, as shown in FIG. 3, a concrete block 2 of the same dimensions as that of the example above is produced, in which two non-corroded sensors 1 and 1″, identical to the sensor 1 of the previous example, are embedded, located respectively at 1.5 and 3 cm of depth, and separated by around 7 cm.

An excitation for a period of around 2 minutes is applied (the first trials with the same duration as in the example above did not allow the deeper sensor to be identified).

FIG. 3A shows in the thermographic images, respectively, the surface (a) and the side (b) of the concrete block 2 just after the excitation has been stopped.

The hot points P1 and P1″ generated respectively by sensors 1 and 1″ are clearly seen in the profile view (b).

It may be observed that the temperature of the hot point P1 generated by the sensor 1 at the shallower depth is much higher than that of the hot point P1″ generated by the deeper sensor 1″ (i.e. 35° C. by comparison with around 33° C., respectively).

This is due to the fact that the coil used generates a magnetic field that decreases rapidly with distance.

It is less easy to see the hot point generated by the deepest sensor 1″ from the top view (a) than from the profile view; indeed, because of this greater depth, the heat flow coming from this sensor takes more time to spread and has been reduced by the time it arrives at the surface.

From the top view (a), the hot point P1 generated by the sensor 1 at a shallower depth is therefore essentially observed.

FIG. 3B shows the thermographic images obtained 1 minute after the excitation has been stopped.

In consideration of the significant influence of the depth of the sensor in the structure, below, the suitable dimensions of the sensor and excitation time will be determined as a function of the depth of the sensor.

To this end, the sensor and the heating system are separated by a section of concrete of variable thickness and, after excitation, the temperature of the sensor is obtained.

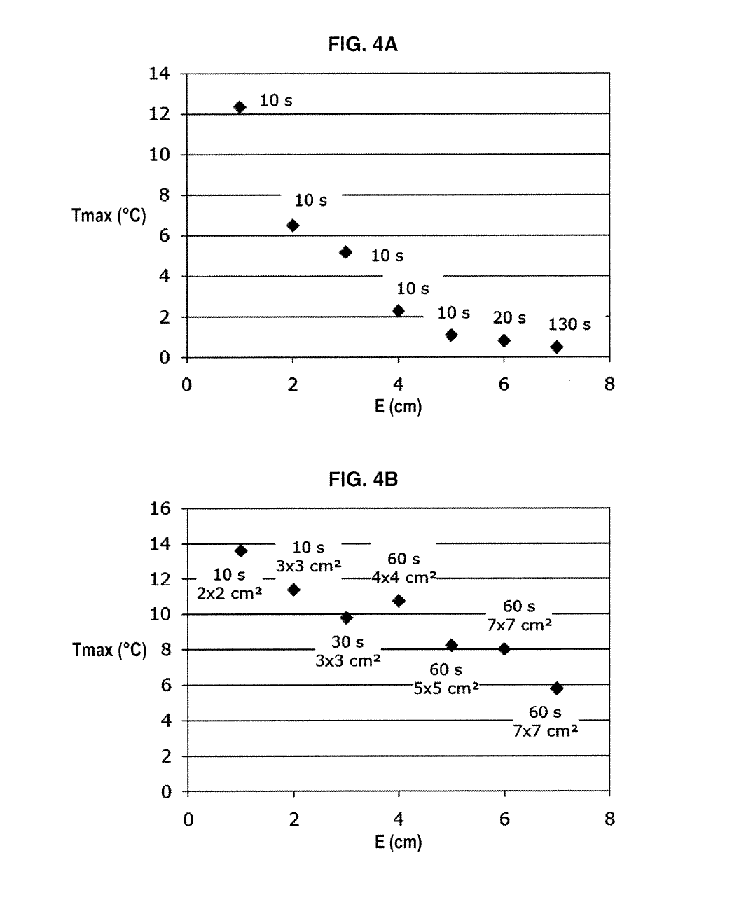

The graph of FIG. 4A shows the increase in maximum temperature Tmax of a sensor that is 2×2 cm² and 100 micrometers thick as a function of the thickness E of the concrete covering it.

The duration of the excitation (in seconds) is indicated for each measurement point.

A clear decrease in temperature reached by the sensor is observed with the concrete thickness.

This suggests that the magnetic induction is not enough to heat such a small metal surface, when the concrete thickness becomes high.

In a second step, we determine the sensor surface necessary for obtaining, for example, an increase in maximum temperature greater than 5° C. so as to be able to easily read the temperature with an excitation time of less than 60 seconds.

The graph of FIG. 4B shows the results obtained with different sensor surfaces (the thickness is always 100 micrometers), different excitation times and different concrete thicknesses.

It is concluded that the greater the depth of the sensor is, the more the surface thereof and the excitation time must be high in order for the increase in temperature of the sensor to be detectable by the thermographic camera.

### Experimental Example No. 3

### Influence of the Presence of Metal Reinforcements

The influence of the presence of metal reinforcements, which are very commonly used in concrete structures, was also evaluated.

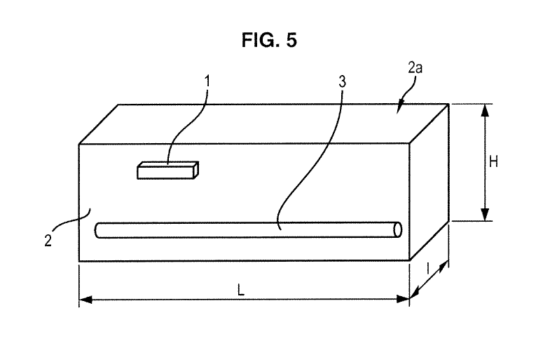

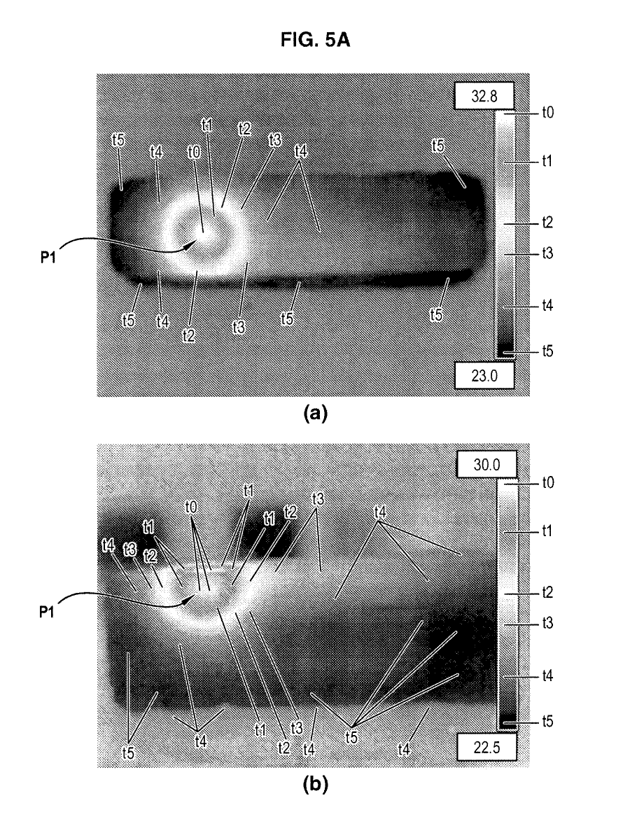

To this end, a concrete block 2 with dimensions identical to those of the previous examples was constructed, as shown in FIG. 5, in which a non-corroded sensor 1 identical to the sensor 1 of the previous examples, at a depth of 1 cm, and a metal bar 3 with a diameter of 10 mm and a depth of 4 cm in the direction of the length of the block 2 were embedded.

The block was excited with the same device as before, for a period of 50 seconds.

FIG. 5A shows the thermographic images (a) of the surface 2a of the block 2 and (b) of the side.

It is noted that the hot point P1 generated by the sensor 1 is seen, but no hot point generated by the bar 3 is seen.

The heating of the non-corroded sensor 1 is in fact significantly promoted with respect to that of the bar 3, because only the skin thickness heats during excitation by magnetic induction.

As the sensor 1 has a smaller volume by comparison with its surface, the thermal power distributed per unit of volume is greater, and the temperature increase is therefore greater.

### Example No. 4

### Examples of Optimized Parameters Under Real Conditions

The measurement parameters are dependent on heating and reading apparatuses.

To determine these parameters with the available apparatuses, a concrete post was produced in which circular sensors of different diameters, having a thickness of 100 micrometers, were placed at different depths.

The parameters in the table below could thus be obtained.

The sensors were heated with a generator similar to that of the previous examples.

The results were obtained from images taken by an infrared camera IC 080 V of the TROTEC company, having a resolution of 160×120 pixels and a thermal sensitivity of 0.1° C.

An excitation time of several minutes is considered to be acceptable for inspection of a structure.

| | Sensor | Sensor | |
|---|---|---|---|
| Sensor depth | diameter | surface area | Induction |
| (cm) | (cm) | (cm²) | time (min) |
| 1 | 2 | 3 | 2 |
| 2 | 6.2 | 30 | 2 |
| 3 | 10 | 80 | 3 |
| 4 | 10 | 80 | 3 |

In concrete building and structure constructions, the metal reinforcements are long and embedded more deeply than the sensors. Consequently, almost all of the reinforcement is not excited by induction; the remainder of the reinforcement then acts as a radiator to dissipate the heat, producing an even lower increase in temperature.

The method described above therefore makes it possible to clearly distinguish different degrees of corrosion of sensors embedded in a concrete structure.

As this method preferably causes heating of the conductive elements having a high surface-to-volume ratio (which is the case of the sensors), the measurement is not disrupted by the presence of regular metal reinforcements.

The measurement can also be performed regardless of the depth of the sensors (on the condition that a suitable excitation period is used, as seen above). In particular, and contrary to what occurs with radars (dead zone effect), it is possible to use sensors located very close to the surface of the concrete.

The minimal depth is determined according to the type of structure in which the sensors will be installed. According to the type of structure, this depth may be between several mm and several dozens of mm.

To produce the structure of which the corrosion is subsequently to be inspected by the above-described process, one or more sensors is positioned, preferably at different depths, while the concrete is being poured.

In general, the sensors are placed in between the surface of the concrete and the first reinforcement bed, i.e. between 0.1 and 8 to 10 cm according to the type of structure.

The sensors are oriented so that their largest surface is parallel to the surface of the concrete.

It is possible to provide an identification on or in the concrete to identify the positioning and/or the depth of the sensors. For example, a chip can be installed in the concrete to indicate the characteristics of the various sensors present.

Advantageously, each sensor is calibrated by taking one or more thermographic images shortly after the structure is produced.

These images are then used as a reference and may be compared to images taken later, so as to determine whether the sensor has become corroded, thereby enabling the change over time of the corrosion front in the structure to be defined.

Another advantage of this method is that it enables an analysis directly based on thermographic images, and it is implemented in several minutes, with more lightweight and less expensive equipment than the existing equipment.

The inspection of the structures is therefore largely facilitated.

Finally, it goes without saying that the examples provided above are merely specific illustrations that are in no way limiting to the fields of application of the invention.

1. A process for controlling the corrosion of a concrete structure, wherein said structure includes at least one sensor comprising a metal element located at a determined depth between the surface of the concrete and the first reinforcement bed, said process including, for said sensor, the measurement of the corrosion of said metal element by implementing:
the induction heating of said metal element, by applying magnetic excitation above the surface of the structure,
the production of at least one thermographic image of the surface of the structure,
and the deduction, on the basis of the thermographic image, of the degree of corrosion of the metal element.

2. The process of claim 1, wherein a plurality of successive thermographic images are obtained after the magnetic excitation is stopped, so as to measure the change over time in the temperature of said metal element.

3. The process of claim 1, wherein a plurality of successive thermographic images are obtained after the magnetic excitation is stopped, so as to distinguish, by their temperature, at least two metal elements visible in said images.

4. The process of claim 1, wherein the magnetic excitation is applied with a magnetic field having an intensity greater than 0.1 mT, a frequency of between 10 kHz and 1 MHz and at a distance of between 0.1 cm and 10 cm with respect to the surface of the structure.

5. The process of claim 1, wherein the sensor is arranged at a depth of between 0.1 and 10 cm below the surface of the concrete.

6. The process of claim 1, wherein the sensor consists of a metal sheet parallel to the surface of the concrete and of which the thickness is between 20 and 500 micrometers.

7. The process of claim 1, wherein the metal element includes a surface state suitable for controlling the localization of the initiation of the corrosion and, as the case may be, the propagation of same.

8. The process of claim 1, wherein the dimensions of the metal element and the duration of the magnetic excitement are chosen so as to lead to an increase in its temperature by at least 2° C.

9. A process for producing a concrete structure, wherein at least one sensor including a metal element is placed in the concrete in order to subsequently implement the corrosion inspection process of claim 1.
